(19) United States
(12) Patent Application Publication
(10) Pub. No.: US 2001/0031628 A1
(43) Pub. Date: Oct. 18, 2001

(54) Integrated circuit device and commuunication apparatus using the same

(75) Inventors: Yoshikuni Higashikawa, Nagaokakyo-shi (JP); Hiroki Fujiwara, Nagaokakyo-shi (JP); Hiroshi Taniguchi, Yasu-gun (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/885,205

(22) Filed: Jun. 19, 2001

Related U.S. Application Data
(63) Continuation of application No. 09/458,601, filed on Dec. 10, 1999.

(30) Foreign Application Priority Data
Dec. 11, 1998 (JP) 10-352952

(51) Int. Cl. H04B 1/26

(52) U.S. Cl. 455/313; 455/318

(57) ABSTRACT

An integrated circuit device for frequency conversion in a CATV tuner, in which the signal output from an oscillation circuit section has an improved phase noise characteristic. The mixer circuit section, including an RF input port, an LO input port, and an IF output port, and an oscillation circuit section connected to the LO input port of the mixer circuit section, may be formed on one semiconductor substrate, or on separate substrates. The mixer circuit section uses an FET as a nonlinear element and the oscillation circuit section uses a bipolar transistor as an oscillation element. By this constitution the phase noise of the signal outputted from the oscillation circuit section can be made small.

### BACKGROUND OF THE INVENTION

1. Field of the Invention

This invention relates to an integrated circuit device and a communication apparatus using same. More particularly, the invention relates to an integrated circuit device for carrying out frequency conversions in a cable television (CATV) tuner, and to a communication apparatus using same.

2. Description of the Related Art

In recent years, integrated circuit designs for the frequency-conversion section of a CATV tuner have been developed in accordance with the size-reduction of CATV tuners.

A conventional integrated circuit device comprising a frequency-conversion section is shown in FIG. 11. In FIG. 11, a GaAs integrated circuit device 1 comprises both a mixer circuit section 2 and an oscillation circuit section 3, both integrated on one GaAs semiconductor substrate 8. The mixer circuit section 2 has a bonding pad for an RF input port 4, a bonding pad for an IF output port 5, and a bonding pad for a local oscillator (LO) output port 7. The oscillation circuit section 3 has a bonding pad for a control voltage terminal 6, the oscillation circuit section 3 being a voltage controlled oscillator. A resonance circuit which determines the oscillation frequency of the oscillation circuit section 3 may be incorporated in the oscillation circuit section 3, or the resonance circuit may be an external component which is attached to the outside of the oscillation circuit section 3 depending on demand. Moreover, the mixer circuit section 2 has an LO input port which is connected to the oscillation circuit section 3. Since the mixer circuit section 2 and the oscillation circuit section 3 are connected inside the device, the LO input port is not illustrated in FIG. 11.

A GaAs MESFET (Metal Semiconductor FET) is employed as a nonlinear element in the mixer circuit section 2. Similarly another GaAs MESFET is employed as an oscillation element in the oscillation circuit section 3. Therefore, the mixer circuit section 2 and the oscillation circuit section 3 can be manufactured in the same process. Another advantage of the GaAs MESFET is that the distortion factor characteristic and the noise factor characteristic can be made small.

The block diagram of the integrated circuit device 1 of FIG. 11 is shown in FIG. 12. The mixer circuit section 2 comprises a Gilbert cell type mixer circuit 2a and phase splitters 2b and 2c. The oscillation circuit section 3 comprises an oscillator 3a.

In the integrated circuit device 1, the RF signal inputted from the RF input port 4 is divided into two signals with different phases by the phase splitter 2b, which are inputted into the mixer circuit 2a. Meanwhile, the LO signal is generated in the oscillator 3a of the oscillation circuit section 3. Part of the LO signal is outputted from the LO output port 7, and the remainder is inputted into the phase splitter 2c of the mixer circuit section 2 via the LO input port (not numbered). The LO signal inputted into the phase splitter 2c is divided into two signals with different phases, which are inputted into the mixer circuit 2a. In the mixer circuit 2a the inputted RF signal and the inputted LO signal are mixed, and a difference or a sum of the signals is outputted to the IF output port 5. Thereby a frequency conversion is performed. In addition, the LO signal outputted from the LO output port 7 is connected to a Phase Locked Loop (PLL) circuit, wherein the signal is used to stabilize the output frequency of the oscillation circuit section 3 by PLL control.

A problem with the integrated circuit device 1 shown in FIG. 11 and 12 is that since GaAs MESFET is used as the oscillation element of the oscillation circuit section 3, the 1/f noise is relatively large and the phase noise characteristic of the signal output is not sufficient. Particularly, if the CATV tuner is used to receive digital signals, and the phase noise characteristic of the signal outputted from the oscillation circuit section 3 is poor, the BER (Bit Error Rate) at the time of demodulation can deteriorate, so that that demodulation is not correctly performed.

### SUMMARY OF THE INVENTION

However, the present invention is able to provide an integrated circuit device for frequency conversion wherein the phase noise characteristic of the signal outputted from the oscillation circuit section is improved, and a communication apparatus using same.

In order to solve the above-described problem, the present invention provides an integrated circuit device comprising; a mixer circuit section including an RF input port, an LO input port, and an IF output port; and an oscillation circuit section connected to the LO input port of the mixer circuit section, wherein the mixer circuit section has an FET as a nonlinear element, wherein the oscillation circuit section has a bipolar transistor as an oscillation element.

According to one aspect of the present invention, both the mixer circuit section and the oscillation circuit section can be formed on a single semiconductor substrate.

According to another aspect of the present invention, the mixer circuit section and the oscillation circuit section (except for the bipolar transistor) can be formed on one semiconductor substrate, and the bipolar transistor can be formed individually on another semiconductor substrate, whereby the bipolar transistor is separated from the mixer circuit section and the oscillation circuit section on the semiconductor substrate. Both the oscillation circuit section on its semiconductor substrate and the bipolar transistor on its semiconductor substrate are mounted on a single base substrate.

According to another aspect of the present invention, the mixer circuit section can be formed on a semiconductor substrate and the oscillation circuit section can be formed on another semiconductor substrate, and both the mixer circuit section on the semiconductor substrate and the oscillation circuit section on the other semiconductor substrate are mounted on a single base substrate.

According to another aspect of the present invention, the integrated circuit device further comprises an LO amplifier which amplifies a signal to be inputted to the mixer circuit section from the oscillation circuit section.

According to another aspect of the present invention, the integrated circuit device further comprises a buffer amplifier which amplifies a part of a signal to be inputted to the mixer circuit section from the oscillation circuit section and provides an output to an external circuit.

A communication apparatus of the present invention includes the above described integrated circuit device.

By this constitution, the phase noise of the signal outputted from the oscillation circuit section can be made small in the integrated circuit device of present invention. Moreover, improvement of communication quality can be achieved in the communication apparatus of the present invention.

Other features and advantages of the present invention will become apparent from the following description of the invention which refers to the accompanying drawings.

### BRIEF DESCRIPTION OF THE DRAWINGS

FIG. 1 is a perspective view showing an embodiment of an integrated circuit device of the present invention.

FIG. 2 is a perspective view showing another embodiment of an integrated circuit device of the present invention.

FIG. 3 is a perspective view showing still another embodiment of an integrated circuit device of the present invention.

FIG. 4 is a perspective view showing still another embodiment of an integrated circuit device of the present invention.

FIG. 5 is a block diagram of the integrated circuit device shown in FIG. 4.

FIG. 6 is a perspective view showing still another embodiment of an integrated circuit device of the present invention.

FIG. 7 is a block diagram of the integrated circuit device shown in FIG. 6.

FIG. 8 is a perspective view showing still another embodiment of an integrated circuit device of the present invention.

FIG. 9 is a block diagram of the integrated circuit device shown in FIG. 8.

FIG. 10 is a block diagram showing an embodiment of a communication apparatus of the present invention.

FIG. 11 is a perspective view showing a conventional integrated circuit device.

FIG. 12 is a block diagram of the integrated circuit device shown in FIG. 11.

### DETAILED DESCRIPTION OF EMBODIMENTS OF THE INVENTION

An embodiment of an integrated circuit device of the present invention is shown in FIG. 1. In FIG. 1, the same symbols 5 are provided for the same or equivalent parts as in FIG. 1, and the relevant explanation is omitted. In FIG. 1, an oscillation circuit section 11 of an integrated circuit device 10 is formed on the semiconductor substrate 8. The mixer circuit section 2 is also formed thereon. In such a constitution, at least an oscillation element of the oscillation circuit section 11 is a bipolar transistor, which is formed by a bipolar transistor manufacturing process. Specifically, the oscillation circuit section 11 has a GaAs HBT (Heterojunction Bipolar Transistor) formed on a GaAs substrate as the oscillation element, for example. The nonlinear element of the mixer circuit section 2 in this example is a known GaAs MESFET. The block diagram of the integrated circuit device 10 is omitted, since it is the same as that shown in FIG. 12.

By this constitution, since the oscillation element of the oscillation circuit section 11 is the bipolar transistor, the phase noise characteristic of the signal outputted from the oscillation circuit section 11 can be improved.

According to the experimentation of the inventors, the phase noise of an oscillation circuit section using a GaAs MESFET as an oscillation element is 45 dBc/Hz in 1 kHz detuning. By comparison, the phase noise of an oscillation circuit section using a bipolar transistor as the oscillation element is 65 dBc/Hz under the same conditions. It has been confirmed that the phase noise is improved by approximately 20 dB.

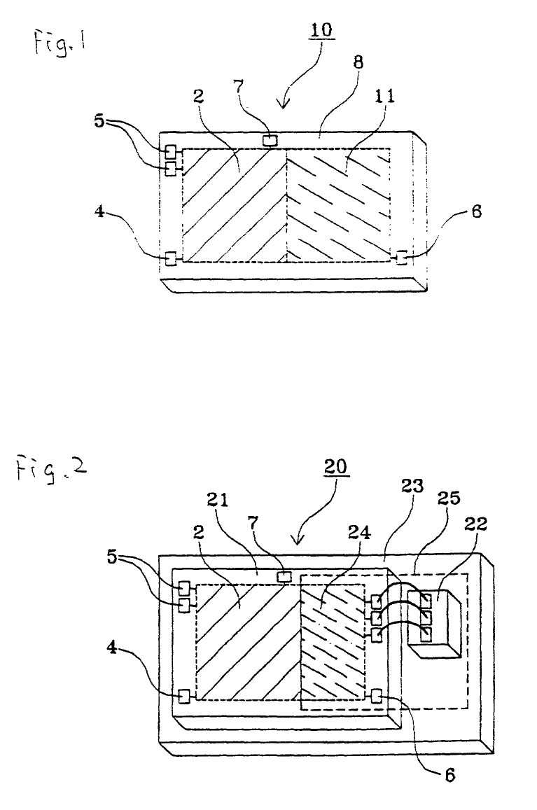

Another embodiment of an integrated circuit device of the invention is shown in FIG. 2. In FIG. 2, the same symbols are provided for the same or equivalent parts as in FIG. 1, and the relevant explanation is omitted. In FIG. 2, an integrated circuit device 20 is provided in which two semiconductor substrates 21 and 22 are mounted on a base substrate 23. The integrated circuit device in its entirety is formed as an MCM (Multi Chip Module) structure. Here, the mixer circuit section 2 and an oscillation circuit sub-section 24 are formed on the semiconductor substrate 21 in the same manufacturing process. The oscillation element is, however, not included in the oscillation circuit sub-section 24. The oscillation element is a bipolar transistor which is individually formed on the semiconductor substrate 22. The oscillation circuit sub-section 24 of the semiconductor substrate 21 and the bipolar transistor of the semiconductor substrate 22 are connected with wires. Consequently, the oscillation circuit section 25 is comprised of the oscillation circuit sub-section 24 of the semiconductor substrate 21 and the bipolar transistor of the semiconductor substrate 22.

Specifically, the mixer circuit including the GaAs MESFET nonlinear element and other circuit elements, such as the oscillation circuit sub-section, are formed on the semiconductor substrate 21. A silicon substrate is used as the semiconductor substrate 22 and a silicon bipolar transistor is formed thereon. Alternatively, a GaAs substrate may be used as the semiconductor substrate 22 and a GaAs HBT may be formed thereon.

In such a constitution of the integrated circuit device 20, only the oscillation element of the oscillation circuit section 25 is formed with the bipolar transistor. The mixer circuit section 2 and the oscillation circuit section (except for the oscillation element of the oscillation circuit section 25) can be formed by the same GaAs MESFET manufacturing process. Thus, the phase noise characteristics of the signal outputted from the oscillation circuit section 25 are improved.

Still another embodiment of an integrated circuit device of the invention is shown in FIG. 3. In FIG. 3, the same symbols are provided for the same or equivalent parts as FIG. 1, and the relevant explanation is omitted. In FIG. 3, an integrated circuit device 30 is provided in which two semiconductor substrates 31 and 32 are mounted on a base substrate 33. The integrated circuit device in its entirety is formed as an MCM (Multi Chip Module) structure. Here, the mixer circuit section 2 is formed on the semiconductor substrate 31 by the GaAs MESFET process. The oscillation circuit section 3 is formed on the semiconductor substrate 32 by the bipolar transistor process. The oscillation circuit section 3 of the semiconductor substrate 32 is connected to a bonding pad for an LO input port 34 of the semiconductor substrate 31 with wires.

Specifically, the mixer circuit section 2 including the nonlinear element of the GaAs MESFET is formed on the semiconductor substrate 31. The oscillation circuit section 3 including a silicon bipolar transistor as the oscillation element is formed on the silicon semiconductor substrate 32. Alternatively, a GaAs substrate may be used as the semiconductor substrate 32 and the oscillation circuit section 3 may include a GaAs HBT as the oscillation element.

Thus in such a constitution of the integrated circuit device 30, since the bipolar transistor is used as the oscillation element of the oscillation circuit section 3, the phase noise characteristic of the signal outputted from the oscillation circuit section 3 is improved.

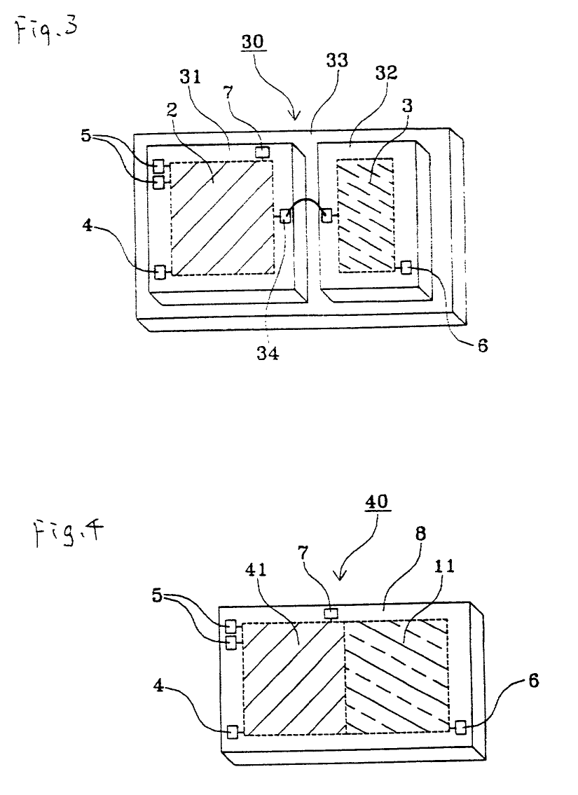

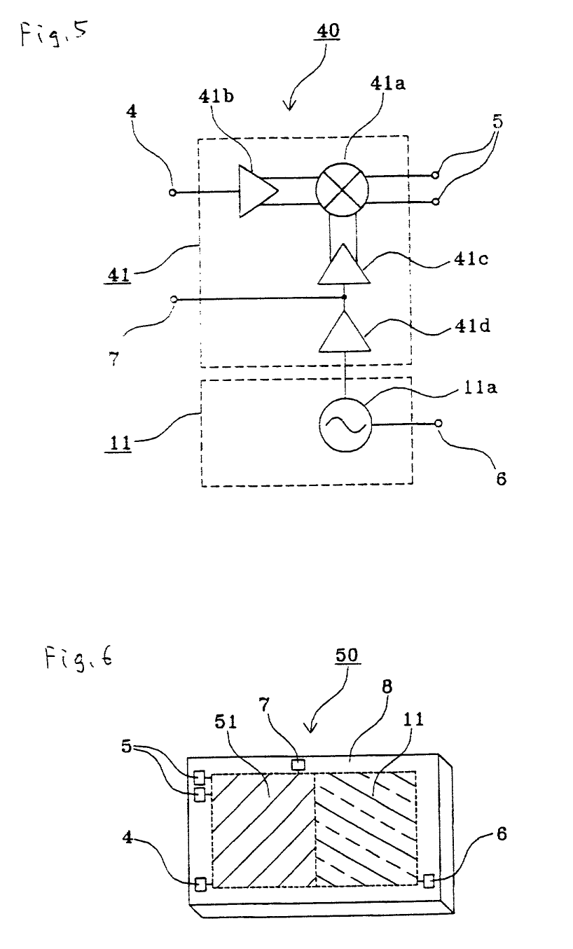

Still another embodiment of an integrated circuit device of the invention is shown in FIG. 4. The block diagram of the integrated circuit device of FIG. 4 is shown in FIG. 5. In FIG. 4, the same symbols are provided for the same or equivalent parts as FIG. 1, and the relevant explanation is omitted.

In FIGS. 4 and 5, a mixer circuit section 41 as well as the oscillation circuit section 11 of an integrated circuit device 40 are formed on the same semiconductor substrate 8. The mixer circuit section 41 comprises a Gilbert cell type mixer circuit 41a, phase splitters 41b and 41c, and an LO amplifier 41d for amplifying a signal from the oscillation circuit section 11. The output of the LO amplifier is input into the phase splitter 41c. The oscillation circuit section 11 comprises an oscillator 11a.

In the integrated circuit device 40, the output level of the oscillation circuit 11a can be low, because of the LO amplifier 41d provided between the oscillation circuit 11a and the phase splitter 41c. Therefore design of the oscillation circuit section 11 is facilitated. Moreover, some margin of error in the design of the oscillation circuit section 11 can be permitted. The yield can be improved, which contributes to lowering the cost of manufacturing the integrated circuit device 40.

Alternatively, although in FIG. 5, the LO output port 7 is connected between the LO amplifier 41d and the phase splitter 41c, the LO output port 7 may also be connected between the oscillation circuit 11a and the LO amplifier 41d.

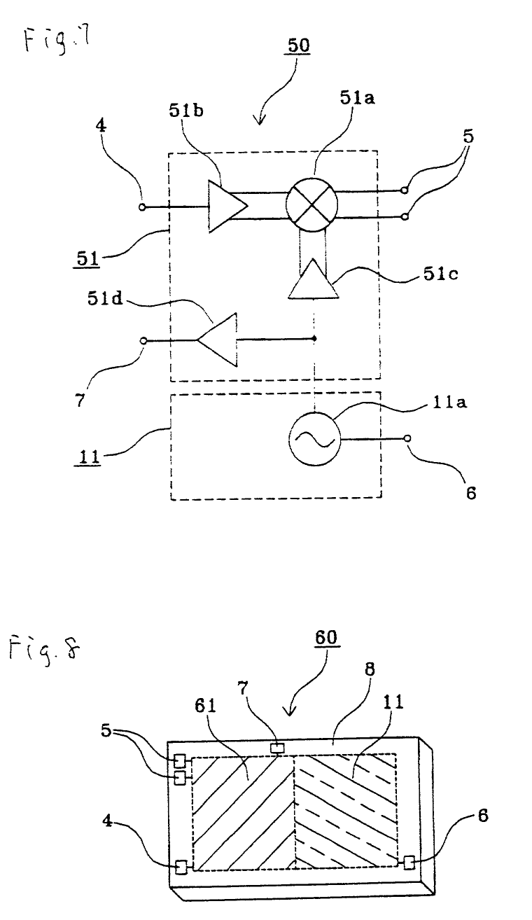

Still another embodiment of an integrated circuit device of the invention is shown in FIG. 6. The block diagram of the integrated circuit device of FIG. 6 is shown in FIG. 7. In FIGS. 6 and 7, the same symbols are provided for the same or equivalent parts as in FIGS. 4 and 5, and the relevant explanation is omitted.

In FIGS. 6 and 7, a mixer circuit section 51 as well as the oscillation circuit section 11 of an integrated circuit device 50 are formed on the same semiconductor substrate 8. The mixer circuit section 51 comprises a Gilbert cell type mixer circuit 51a, phase splitters 51b and 51c, and a buffer amplifier 51d for amplifying apart of a signal from the oscillation circuit section 11 and outputting from the LO output port 7.

In the integrated circuit device 50, by providing the buffer amplifier 51d between the oscillation circuit 11a and the LO output port 7, it is not necessary to provide an extra external buffer amplifier between the integrated circuit device 50 and a PLL circuit. Thus, the size and the cost of the entire integrated circuit device can be reduced. Further, since the major portion of the signal outputted from the oscillation circuit section 11 is able to be inputted into the phase splitter 51c, variation of the output level of oscillation circuit section 11 can be permitted. As in the case of the integrated circuit device 40, the yield can be improved, which contributes to lowering the cost of manufacturing the integrated circuit device 50.

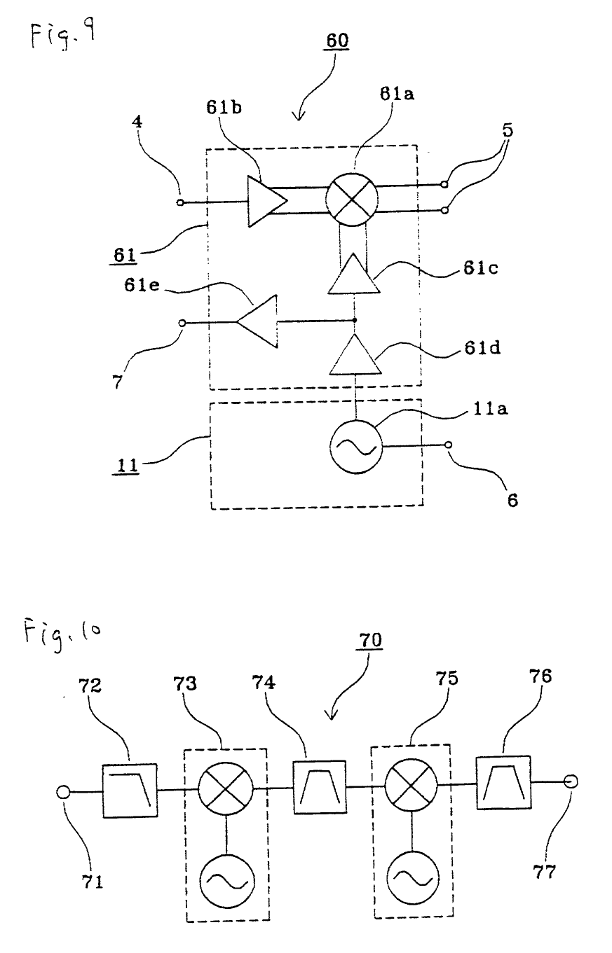

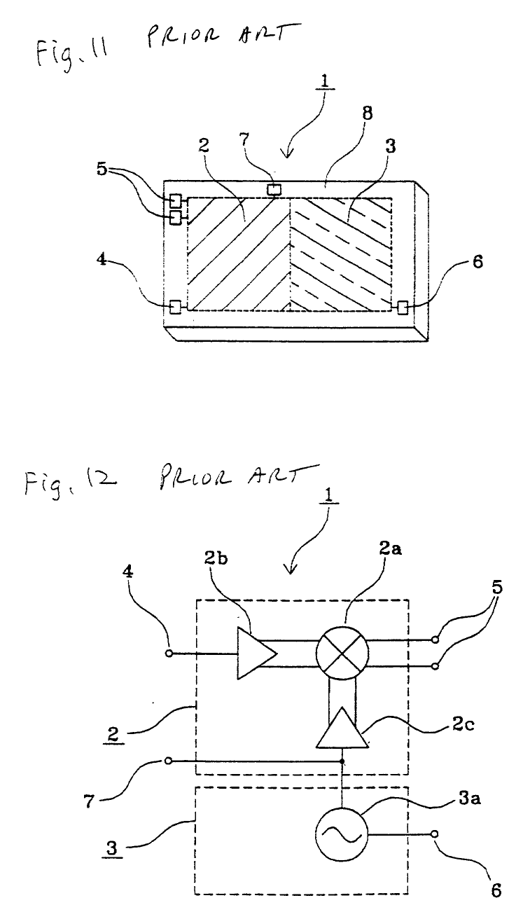

Still another embodiment of an integrated circuit device of the invention is shown in FIG. 8. The block diagram of the integrated circuit device of FIG. 8 is shown in FIG. 9. In FIGS. 8 and 9, the same symbols are provided for the same or equivalent parts as FIGS. 4 and 5, and the relevant explanation is omitted.

In FIGS. 8 and 9, a mixer circuit section 61 of an integrated circuit device 60 is formed on the same semiconductor substrate 8 as the oscillation circuit section 11 thereof. The mixer circuit section 61 comprises a Gilbert cell type mixer circuit 61a, phase splitters 61b and 61c, an LO amplifier 61d for amplifying a signal from the oscillation circuit section 11, and whose output is inputted into the phase splitter 61c, and an buffer amplifier 61e for amplifying a part of the signal outputted from the LO amplifier 61d, and whose output is outputted from the LO output port 7.

In the integrated circuit device 60, the output level of the oscillation circuit 11a can be low, because the LO amplifier 61d is provided between the oscillation circuit 11a and the phase splitter 61c. Therefore design of the oscillation circuit section 11 is facilitated. Moreover, some margin is achieved in the design of the oscillation circuit section 11. The yield can be improved, which contributes to lowering the cost of manufacturing the integrated circuit device. Moreover, it is not necessary to provide an extra external buffer amplifier between the integrated circuit device 60 and a PLL circuit, because the buffer amplifier 61e is provided between the output side of the LO amplifier 61d and the LO output port 7. Thus, the size and cost of the entire integrated circuit device can be lowered.

Although, in FIG. 9, the buffer amplifier 61e is provided between the LO amplifier 61d and the LO output port 7, the buffer amp 61e may alternatively be provided between the oscillation circuit 11a and the LO output port 7.

Note that in each embodiment shown in FIGS. 4 through 9, the integrated circuit device comprises one semiconductor substrate, as in the embodiment shown in FIG. 1. However, the integrated circuit device may be constituted by two semiconductor substrates, both of which are mounted on one base substrate, as in the embodiments shown in FIGS. 2 and FIG. 3.

Note further that though the LO amplifier, the buffer amplifier, and the LO output port are provided in the mixer circuit section, they may also be provided in the oscillation circuit section.

Moreover, although the Gilbert cell type mixer circuit is used in each embodiment, other mixers can be used to obtain similar advantages.

The block diagram of a CATV tuner is shown in FIG. 10 as an embodiment of a communication apparatus of the present invention.

In FIG. 10, a CATV tuner 70 is comprised of an input terminal 71, a low-pass filter 72, an integrated circuit device 73, a band-pass filter 74, an integrated circuit device 75, a band-pass filter 76, and an output terminal 77, which are connected in this order. The two integrated circuit devices 73 and 75 are arranged such that the mixer circuit section and the oscillation circuit section provided in the integrated circuit device 10 of the present invention are configured to accord with the frequencies of the signals to be processed.

In the CATV tuner 70, signals inputted into the input terminal 71 are inputted into the integrated circuit device 73 via the low-pass filter 72. The frequency conversion of the signals inputted into the integrated circuit device 73 is performed, and they are outputted as first IF signals. Unnecessary signals are eliminated by the band-pass filter 74, and the signals are inputted into another integrated circuit device 75. A further frequency conversion of the signals inputted into the integrated circuit device 75 is performed once again, and they are outputted as second IF signals. Unnecessary signals are eliminated by the band-pass filter 76, and they are outputted into the output terminal 77. According to the above steps, a 2-stage frequency conversion is performed in the CATV tuner 70.

Thus, the phase noise characteristics of the local oscillation signal used in the frequency conversion are improved by the CATV tuner 70 using the integrated circuit device 10 of the present invention. Therefore, deterioration of the Bit Error Rate at the time of demodulation of the RF signal, i.e., deterioration of communication quality, can be prevented.

In the CATV tuner 70, the integrated circuit device 10 is employed. However, any one of the integrated circuit devices 20, 30, 40, 50 and 60 can be employed, to obtain the same advantages as when the integrated circuit device 10 is used.

According to the present invention, the integrated circuit device includes a mixer circuit section including an RF input port, an LO input port, and an IF output port; and an oscillation circuit section connected to the LO input port of the mixer circuit section, wherein the mixer circuit section has an FET as a nonlinear element, and the oscillation circuit section has a bipolar transistor as an oscillation element.

In any of the above embodiments, the mixer circuit section and the oscillation circuit section can be formed on one semiconductor substrate. Thus, the phase noise of the signal outputted from the oscillation circuit section is able to be made small. A similar advantage can be obtained by arranging the mixer circuit section and the oscillation circuit section (except for the bipolar transistor) on a semiconductor substrate, and the bipolar transistor can be formed individually on another semiconductor substrate. Both the oscillation circuit section and the bipolar transistor substrate are mounted on the same base substrate. Also, similar advantages can be obtained by forming the mixer circuit section and the oscillation circuit section respectively on two different semiconductor substrates, which are both mounted on the same base substrate.

Moreover, some margin of error in the design of the oscillation circuit section is permitted by providing the LO amplifier for amplifying the signal inputted into the mixer circuit section from the oscillation circuit section.

Further, by providing the buffer amplifier for amplifying a part of the signal inputted to the mixer circuit section from the oscillation circuit section and providing the output to an external circuit, some variation in the output level of the oscillation circuit section is permitted.

According to the communication apparatus of the present invention, improvement of communication quality can be achieved by using the integrated circuit device.

Although the present invention has been described in relation to particular embodiments thereof, many other variations and modifications and other uses will become apparent to those skilled in the art. Therefore, the present invention is not limited by the specific disclosures herein.

What is claimed is:

1. An integrated circuit device comprising:
a mixer circuit section including an RF input port, an LO input port, and an IF output port; and
an oscillation circuit section connected to the LO input port of the mixer circuit section,
wherein the mixer circuit section has an FET as a nonlinear element, and the oscillation circuit section has a bipolar transistor as an oscillation element.

2. An integrated circuit device according to claim 1, wherein both the mixer circuit section and the oscillation circuit section are formed on a single semiconductor substrate.

3. An integrated circuit device according to claim 1,
wherein the mixer circuit section and portions of the oscillation circuit section are formed on a semiconductor substrate, and
the bipolar transistor is formed on another semiconductor substrate, and
both the oscillation circuit section on the semiconductor substrate and the bipolar transistor on the other semiconductor substrate are mounted on a single base substrate.

4. An integrated circuit device according to claim 1, wherein the mixer circuit section is formed on a semiconductor substrate and the oscillation circuit section is formed on another semiconductor substrate, and
both the mixer circuit section on the semiconductor substrate and the oscillation circuit section on the other semiconductor substrate are mounted on a single base substrate.

5. An integrated circuit device according to one of claims 1 to 4, further comprising an LO amplifier which receives and amplifies a signal from the oscillation circuit section, and outputs said signal to the mixer circuit section.

6. An integrated circuit device according to claim 5, further comprising a buffer amplifier which receives and amplifies a signal, from the oscillation circuit section and provides an output to an external circuit.

7. An integrated circuit device according to claim 6, wherein said buffer amplifier is connected to an output of said LO amplifier.

8. An integrated circuit device according to claims 1 to 4, further comprising a buffer amplifier which receives and amplifies a signal, from the oscillation circuit section and provides an output to an external circuit.

9. An integrated circuit device according to claim 8, wherein said buffer amplifier is connected to an output of said LO amplifier.

10. A communication apparatus comprising:
an input terminal;
an output terminal; and
at least one integrated circuit device connected between said input and output terminals, said integrated circuit device comprising:
a mixer circuit section including an RF input port, an LO input port, and an IF output port; and
an oscillation circuit section connected to the LO input port of the mixer circuit section,
wherein the mixer circuit section has an FET as a nonlinear element, and the oscillation circuit section has a bipolar transistor as an oscillation element;
wherein said RF input part is connected to said input terminal and said IF output port is connected to said output terminal.

11. A communication apparatus according to claim 10, further comprising at least one filter connected in series with said at least one integrated circuit device.

12. A communication apparatus according to claim 11, wherein said at least one integrated circuit device comprises a pair of said integrated circuit devices connected in series.

13. A communication apparatus according to claim 10, wherein both the mixer circuit section and the oscillation circuit section are formed on a single semiconductor substrate.

14. A communication apparatus according to claim 10,
wherein the mixer circuit section and portions of the oscillation circuit section are formed on a semiconductor substrate, and
the bipolar transistor is formed on another semiconductor substrate, and
both the oscillation circuit section on the semiconductor substrate and the bipolar transistor on the other semiconductor substrate are mounted on a single base substrate.

15. A communication apparatus according to claim 10, wherein the mixer circuit section is formed on a semiconductor substrate and the oscillation circuit section is formed on another semiconductor substrate, and
both the mixer circuit section on the semiconductor substrate and the oscillation circuit section on the other semiconductor substrate are mounted on a single base substrate.

16. A communication apparatus according to one of claims 10, 13, 14 and 15, further comprising an LO amplifier which receives and amplifies a signal from the oscillation circuit section, and outputs said signal to the mixer circuit section.

17. A communication apparatus according to claim 16, further comprising a buffer amplifier which receives and amplifies a signal, from the oscillation circuit section and provides an output to an external circuit.

18. A communication apparatus according to claim 17, wherein said buffer amplifier is connected to an output of said LO amplifier.

19. A communication apparatus according to one of claims 10, 13, 14 and 15, further comprising a buffer amplifier which receives and amplifies a signal, from the oscillation circuit section and provides an output to an external circuit.
